(19) United States
(12) Patent Application Publication
(10) Pub. No.: US 2024/0013030 A1
(43) Pub. Date: Jan. 11, 2024

(54) AUTOENCODER TRAINING SYSTEM AND METHOD

(71) Applicant: Fujitsu Limited, Kawasaki-shi (JP)

(72) Inventor: Meguru YAMAZAKI, Kawasaki (JP)

(73) Assignee: Fujitsu Limited, Kawasaki-shi (JP)

(21) Appl. No.: 18/193,858

(22) Filed: Mar. 31, 2023

(30) Foreign Application Priority Data
Jul. 7, 2022 (JP) 2022-109848

(51) Int. Cl. G06N 3/0455

(52) U.S. Cl. CPC G06N 3/0455

(57) ABSTRACT

An autoencoder training system includes: a memory; and a processor coupled to the memory and configured to: specify, as division position candidates, positions behind respective layers in which an amount of output data is reduced relative to an amount of input data, among layers included in a deep neural network model; and perform, for each of the division position candidates, machine learning on an autoencoder to be inserted between a first apparatus in which a first layer group from an input layer to a division position is deployed and a second apparatus in which a second layer group from the division position to an output layer is deployed.

### CROSS-REFERENCE TO RELATED APPLICATION

This application is based upon and claims the benefit of priority of the prior Japanese Patent Application No. 2022-109848, filed on Jul. 7, 2022, the entire contents of which are incorporated herein by reference.

### FIELD

The disclosed technology is related to an autoencoder training system and an autoencoder training method.

### BACKGROUND

There is known a method called collaborative intelligence (CI) that aims at the efficient use of overall calculation resources by dividing a deep neural network (DNN) model between layers, deploying the layers in an edge terminal and cloud in a distributed manner, and performing inference processing. In CI, an amount of calculation desired for the edge terminal and a desirable communication band between the edge terminal and the cloud vary depending on the division position of the DNN model. For this reason, the division position of the DNN model is dynamically changed in accordance with requisites of a user and an environment.

U.S. Patent Application Publication No. 2020/0082259 is disclosed as related art.

### SUMMARY

According to an aspect of the embodiments, an autoencoder training system includes: a memory; and a processor coupled to the memory and configured to: specify, as division position candidates, positions behind respective layers in which an amount of output data is reduced relative to an amount of input data, among layers included in a deep neural network model; and perform, for each of the division position candidates, machine learning on an autoencoder to be inserted between a first apparatus in which a first layer group from an input layer to a division position is deployed and a second apparatus in which a second layer group from the division position to an output layer is deployed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a schematic configuration of an autoencoder (AE) training system according to the present embodiment;

FIG. 2 is a schematic diagram for describing CI;

FIG. 3 is a diagram for describing how an AE is used in CI;

FIG. 4 is a diagram for describing an example of characteristics of a feature quantity for each layer;

FIG. 5 is a diagram illustrating dividable positions in a Visual Geometry Group (VGG);

FIG. 6 is a functional block diagram of a training apparatus;

FIG. 7 is a diagram for describing data reduction by a max pooling layer;

FIG. 8 is a diagram illustrating an example of division position candidates in the VGG;

FIG. 9 is a diagram for describing an adjustment granularity for each block;

FIG. 10 is a diagram illustrating an example of division position candidates after addition by an adding unit;

FIG. 11 is a functional block diagram of an edge terminal;

FIG. 12 is a functional block diagram of a cloud server;

FIG. 13 is a diagram illustrating relationships among a target model, trained AEs, and individual functional units of the edge terminal and the cloud server;

FIG. 14 is a block diagram illustrating a schematic configuration of a computer that functions as the training apparatus;

FIG. 15 is a block diagram illustrating a schematic configuration of a computer that functions as the edge terminal;

FIG. 16 is a block diagram illustrating a schematic configuration of a computer that functions as the cloud server;

FIG. 17 is a flowchart illustrating an example of training processing;

FIG. 18 is a flowchart illustrating an example of coarse search processing;

FIG. 19 is a flowchart illustrating an example of detailed search processing; and

FIG. 20 is a flowchart illustrating an example of inference-time processing.

### DESCRIPTION OF EMBODIMENTS

A feature quantity compression technique is present which reduces a desirable communication band between an edge terminal and cloud by compressing, with an autoencoder, a feature quantity that is an edge-side output in CI.

As a technique for determining the division position of the DNN model, there has been proposed a system for selecting a subset of a set of intermediate representations closest to input information in a deep learning inference system including a plurality of layers each of which generates one or more related intermediate representations, for example. By using the selected subset of intermediate representations, this system determines a division point, among a plurality of layers, used for dividing the plurality of layers into two sections defined such that information leakage of the two sections conforms to a privacy parameter when information leakage of one of the two sections is suppressed. This system outputs the division point used for dividing the plurality of layers of the deep learning inference system into two sections.

An autoencoder is a neural network, and is to be trained in accordance with a DNN model to which the autoencoder is to be inserted. Since the characteristics of a feature quantity output from each layer of the DNN model vary from layer to layer. Thus, to further increase the data reduction performance, the autoencoder is to be trained for each dividable position of the DNN model.

However, in a case where the autoencoder is trained for each of all the dividable positions of the DNN model including many layers, an amount of calculation for training becomes enormous.

As one aspect, an object of the disclosed technology is to reduce an amount of calculation related to training of an autoencoder to be inserted at a division position of a DNN model.

An example of an embodiment according to the disclosed technology will be described below with reference to the drawings.

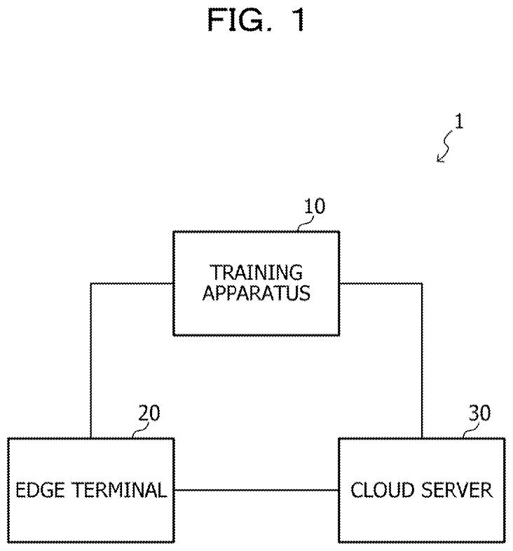

FIG. 1 illustrates a schematic configuration of an autoencoder (AE) training system 1 according to the present embodiment. The AE training system 1 includes a training apparatus 10, an edge terminal 20, and a cloud server 30. The edge terminal 20 is an example of a “first apparatus” in the disclosed technology. The cloud server 30 is an example of a “second apparatus” in the disclosed technology.

In the AE training system 1, a target deep neural network (DNN) model (hereinafter, referred to as a “target model”) for performing inference processing is deployed in the edge terminal 20 and the cloud server 30 in a divided manner, and the inference processing is performed by collaborative intelligence (CI). The training apparatus 10 trains the AE to be inserted at a division position of the target model.

An overview of CI and an issue in training of an AE in CI will be described.

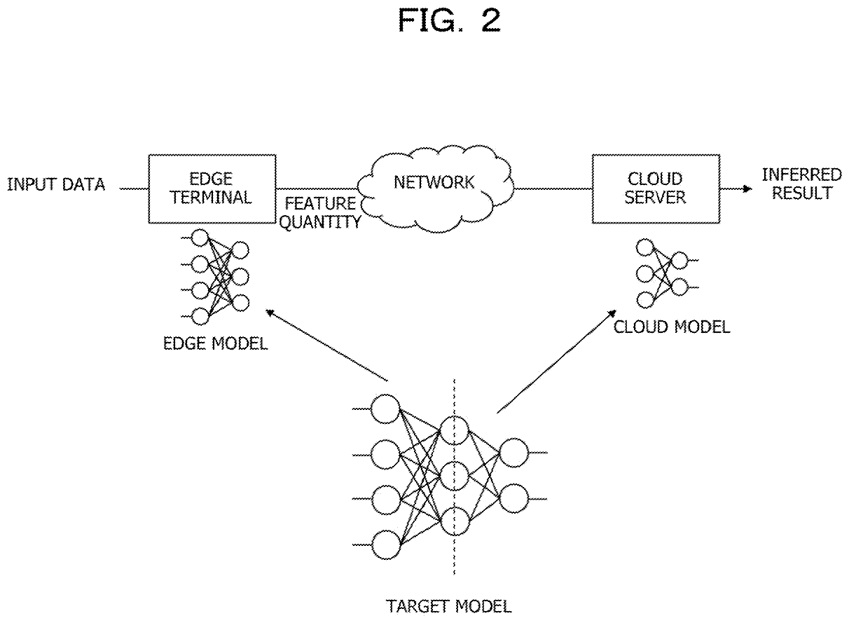

FIG. 2 illustrates a schematic diagram of CI. As illustrated in FIG. 2, a DNN model, which is a target model, is divided between any layers in CI. An edge model constituted by a layer group from an input layer to a division position is deployed in an edge terminal, and a cloud model constituted by a layer group from the division position to an output layer is deployed in a cloud server. The edge terminal acquires input data such as image data, and performs, with the edge model, inference processing that is a first half of the target model. The edge terminal transmits a feature quantity, which is an intermediate layer output of the target model, to the cloud server via a network. The cloud server acquires the feature quantity from the edge terminal, performs, with the cloud model, inference processing that is a latter half of the target model, and acquires an inferred result. In this manner, the calculation resources of the edge terminal may be used effectively.

As the division position of the target model in CI, a division position satisfying a requisite of an application is selected. For example, a division position is selected that minimizes an end-to-end delay from input of input data to the edge terminal to output of the inferred result from the cloud server, for example, a processing time in the edge terminal and the cloud server and a transfer time via the network. For example, a division position is selected that minimizes power consumption at the edge terminal, for example, power to be consumed by the edge terminal during inference processing and power to be consumed to transmit the feature quantity to the network.

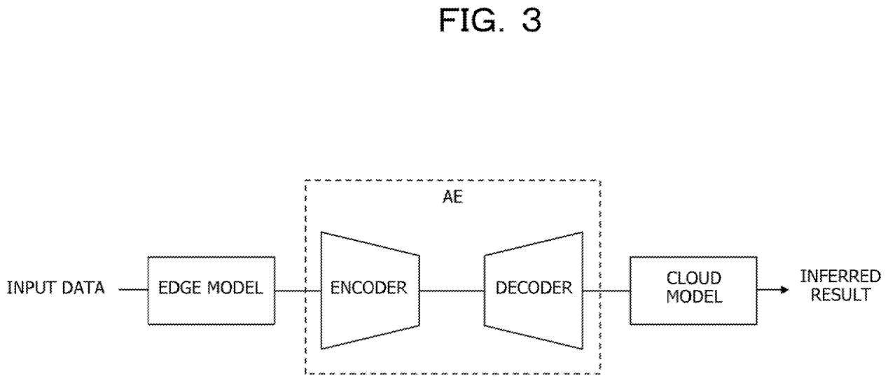

An AE is inserted at the division position of the target model, compresses the feature quantity to be transmitted from the edge terminal to the cloud server, and thus reduces a desirable band of the network. The AE is a neural-network-based dimension reduction method, and is constituted by an encoder that reduces a dimension (data) and a decoder that restores the dimension (data). For example, as illustrated in FIG. 3, the encoder of the AE extracts data to be used for the inference processing from the feature quantity that is the output of the edge model and reduces a data size, so that the feature quantity is compressed. The compressed feature quantity is decompressed by the decoder, and the decompressed feature quantity is input to the cloud model. The AE is trained to optimize a loss function including an error between compression-target original data and decompressed data and a data size of the compressed data.

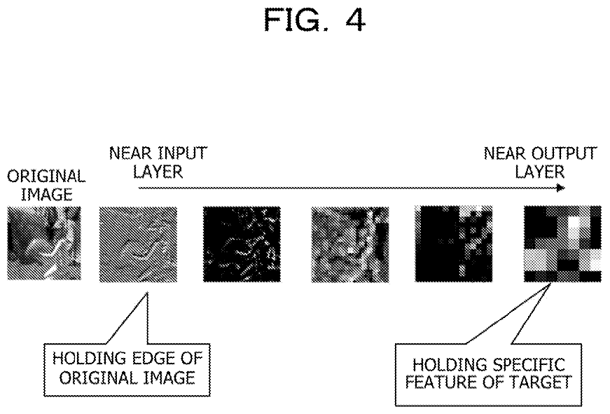

The characteristics of the feature quantity output from each layer of the DNN model that is the target model vary from layer to layer. For example, in a case where input data is an image, a feature quantity that is an output of a layer near the input layer is a feature quantity holding an edge or the like of an original image as illustrated in FIG. 4. As the layer approaches the output layer, the feature quantity gradually becomes a feature quantity holding more specific features of the target such as a face of a person, a fish, or a car. For this reason, to finely adjust the division position in accordance with the requisite of the application while maintaining the high data reduction performance provided by the AE, training is desirably performed with the AE being inserted at each dividable position.

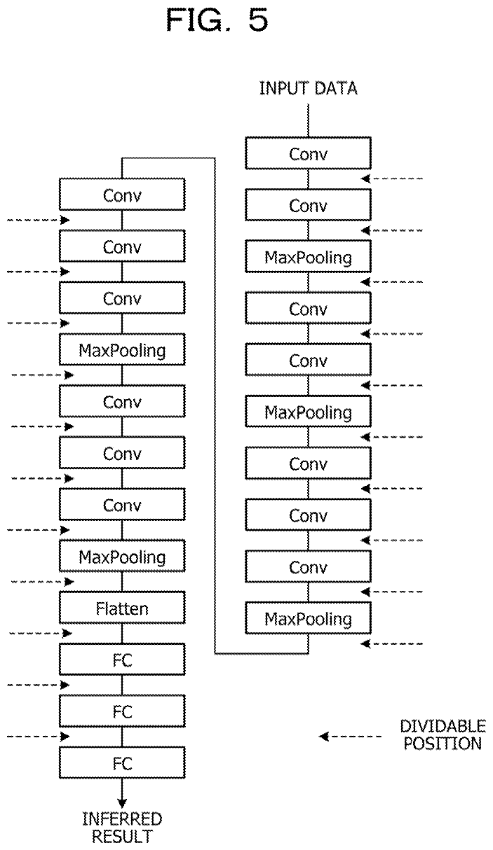

A dividable position is between individual layers of the target model. For example, in a case where the target model is VGG16, there are 21 dividable positions as illustrated in FIG. 5. In FIG. 5, “Cony” denotes a convolution layer, “MaxPooling” denotes a max pooling layer, “Flatten” denotes a layer that converts three-dimensional feature quantity data into one-dimensional feature quantity data, and “FC” denotes a fully connected layer. In a case where the target model is Resnet50, there are 18 dividable positions. In a case where the AE is trained for each of all of these dividable positions, the amount of calculation becomes enormous.

Accordingly, in the present embodiment, the amount of calculation in training of the AE is reduced by selecting some of the dividable positions of the target model as division position candidates and training the AE for each of the selected division position candidates. Hereinafter, each of the training apparatus 10, the edge terminal 20, and the cloud server 30 included in the AE training system 1 will be described in detail.

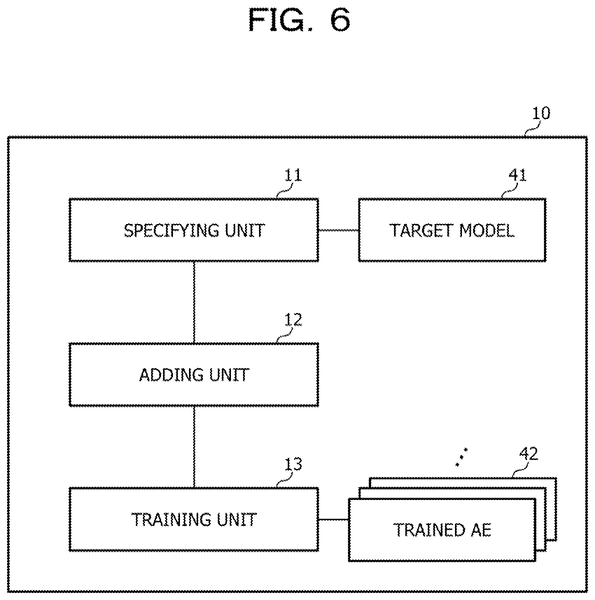

FIG. 6 is a functional block diagram of the training apparatus 10. As illustrated in FIG. 6, the training apparatus 10 includes a specifying unit 11, an adding unit 12, and a training unit 13 in terms of functions. A target model 41 and trained AEs 42 are stored in a predetermined storage area of the training apparatus 10.

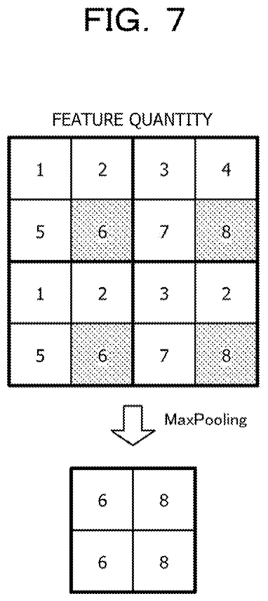

Among layers included in the target model 41, the specifying unit 11 specifies, as division position candidates, positions behind respective layers in which the amount of output data is reduced relative to the amount of input data. For example, layers of a convolutional neural network (CNN) include layers in which the number of pixels is reduced, such as a max pooling layer and a convolution layer having two or more strides. Because unnecessary data is greatly reduced in these layers, the data size may be greatly reduced by inserting the AE immediately behind these layers. For example, as illustrated in FIG. 7, in the case of the max pooling layer, the maximum value (shaded portion in FIG. 7) of the feature quantity in each predetermined region (2×2 pixels in an example of FIG. 7) is output. Accordingly, in a case where the target model is divided at a position ahead of the max pooling layer, the AE is desirably trained to compress the feature quantity by taking into account the data in the shaded portions being data to be used in the inference processing performed later. On the other hand, in a case where the target model is divided at a position behind the max pooling layer, unnecessary data is reduced and all the data to be used in the inference processing later becomes an input to the AE, so that unnecessary training is not to be performed.

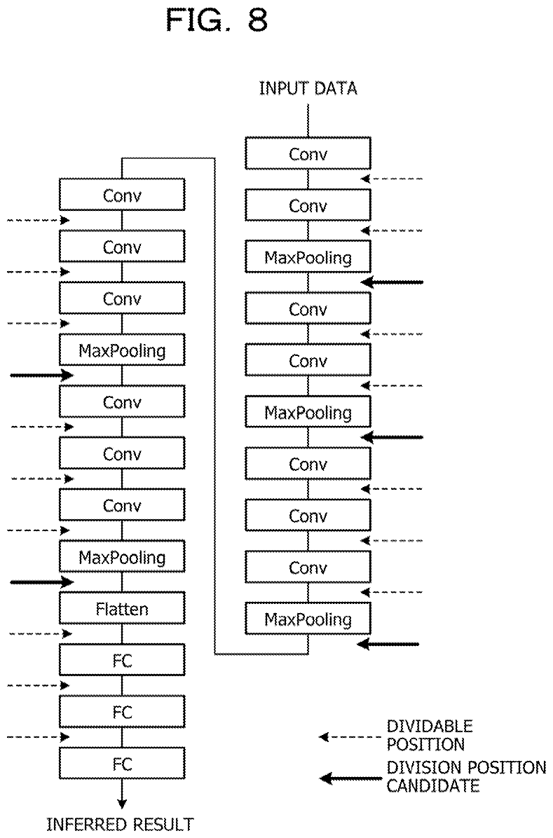

For example, the specifying unit 11 analyzes the target model 41 and acquires, as layer information, the number of pixels and the number of channels output by each layer. The specifying unit 11 specifies a position immediately behind each layer as a dividable position. The specifying unit 11 compares the layer information of each layer with the layer information of an immediately preceding layer, searches for a layer in which the amount of data is reduced, and specifies the dividable position behind that layer as a division position candidate. The specifying unit 11 may acquire the type, the number of strides, or the like of each layer as the layer information, search for a layer in which data is reduced based on the acquired layer information, and specify the position behind that layer as a division position candidate. FIG. 8 illustrates an example in which division position candidates are specified in an example of the VGG described above.

When a division position at which the AE is actually to be inserted is selected from among the division position candidates, it is desirable that the granularity of the amount of calculation of the edge terminal 20, which changes depending on the selected division position, does not impair the adjustability according to the requisite of the application. Hereinafter, this amount of calculation is referred to as an “adjustment granularity”.

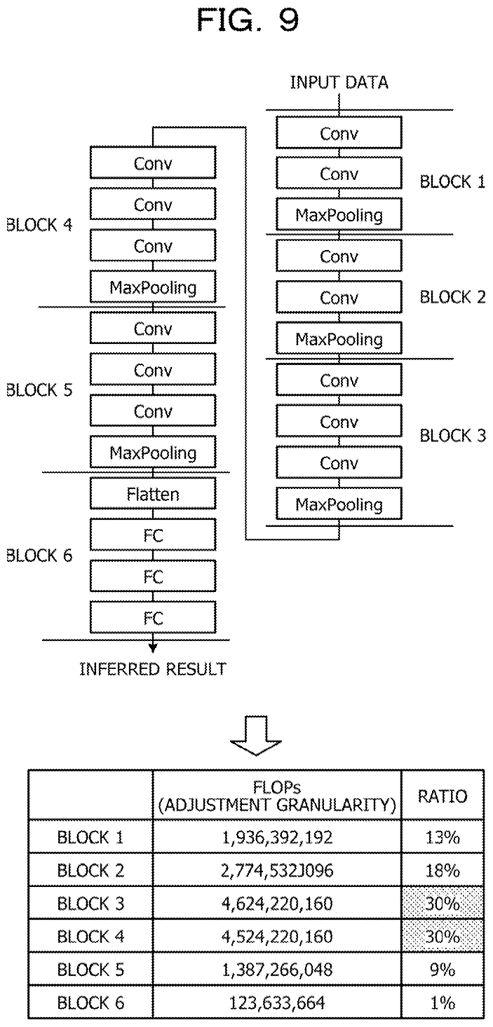

Accordingly, in a case where the adjustment granularity in a layer group included between the division position candidates specified by the specifying unit 11 is greater than a reference value, the adding unit 12 adds a division position candidate between the division position candidates. For example, as illustrated in an upper diagram in FIG. 9, the adding unit 12 sets a section between the division position candidates as a block. The adding unit 12 calculates an amount of calculation for processing in the layer group included in each block, for example, the adjustment granularity. A lower diagram in FIG. 9 illustrates an example in which floating-point operations per second (FLOPs) is calculated as the adjustment granularity of each block.

The adding unit 12 calculates a ratio of the adjustment granularity of each block to the adjustment granularity of all the blocks, and adds a division position candidate in a block of which the ratio is greater than a reference value such that the ratio of the adjustment granularity of each block after the addition of the division position candidate becomes smaller than or equal to the reference value. For example, for a block of which the ratio of the adjustment granularity is greater than the reference value, the adding unit 12 calculates, as the number of to-be-added division position candidates N, a quotient of the ratio of the adjustment granularity divided by the reference value. The adding unit 12 adds the division position candidates at N dividable positions such that the adjustment granularities of respective blocks after the addition of the division position candidates become uniform as much as possible among the dividable positions in this block. Suppose that the reference value is 20% in the example illustrated in FIG. 9. The adding unit 12 adds one division position candidate in each of blocks 3 and 4.

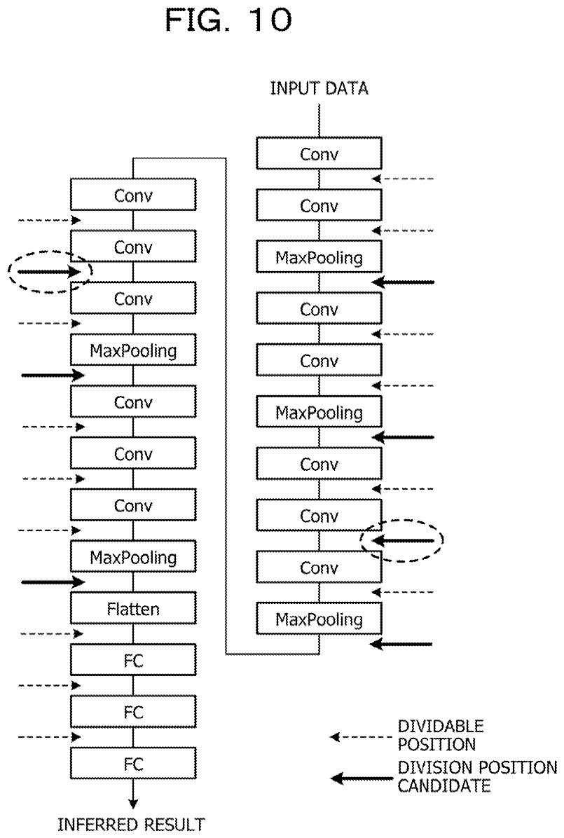

FIG. 10 illustrates an example of division position candidates after the addition by the adding unit 12. In FIG. 10, division position candidates surrounded by broken lines are the division position candidates added by the adding unit 12. In the example illustrated in FIG. 10, since 7 out of 21 dividable positions are specified as the division position candidates, and the AE to be inserted at these division position candidates is trained. Thus, the amount of calculation in training of the AE may be reduced to about ⅓ of the amount of calculation in a case where training is performed for each of all the dividable positions.

For example, the specifying unit 11 performs a coarse search for searching for division position candidates at which the data size of data transmitted from the edge terminal 20 to the cloud server 30 may be reduced greatly from among the dividable positions. The adding unit 12 calculates the amount of calculation in the edge terminal 20 for each block set by the division position candidates obtained in the coarse search, and performs a detailed search for adding the division position candidate to achieve a desired granularity.

The training unit 13 performs, for each of the division position candidates, machine learning on an AE to be inserted between the edge terminal in which the edge model constituted by the layer group from the input layer to the division position is deployed and the cloud server 30 in which the cloud model constituted by the layer group from the division position to the output layer is deployed. For example, the training unit 13 trains the AE to optimize a loss function including an error between a compression-target original feature quantity and a decompressed feature quantity and a compression rate. The training unit 13 stores the trained AE 42 trained for each of the division position candidates in the predetermined storage area.

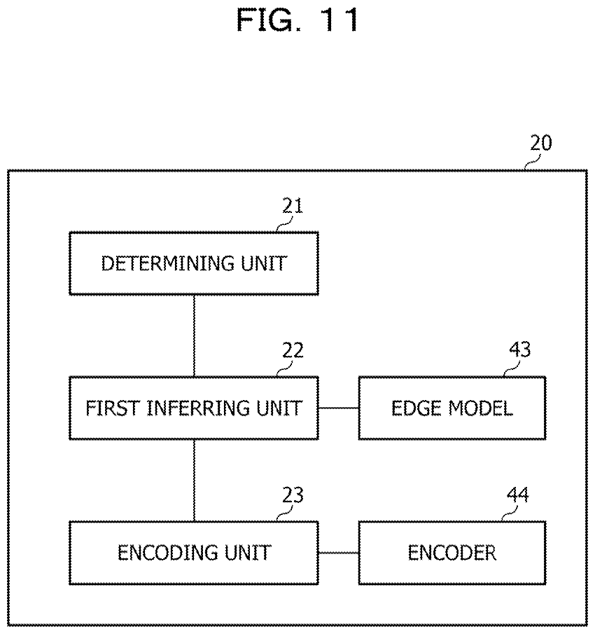

FIG. 11 is a functional block diagram of the edge terminal 20. As illustrated in FIG. 11, the edge terminal 20 includes a determining unit 21, a first inferring unit 22, and an encoding unit 23 in terms of functions. An edge model 43 and an encoder 44 of the AE are stored in a predetermined storage area of the edge terminal 20.

Based on a communication band between the edge terminal 20 and the cloud server 30 and a processing load of each of the edge terminal 20 and the cloud server 30, the determining unit 21 determines a division position at which the AE is to be inserted among the division position candidates.

For example, the determining unit 21 acquires the target model 41 and the trained AE 42 for each division position candidate from the training apparatus 10. The determining unit 21 acquires the current processing load of each of the edge terminal 20 and the cloud server 30, and predicts, for each of the division position candidates, the processing time in each of the edge terminal and the cloud server 30 by using a processing time prediction model such as a regression model. The determining unit 21 predicts a data size of the feature quantity after the feature quantity which is the output of the edge model 43 at each division position candidate is compressed by the trained AE 42 corresponding to that division position candidate. The determining unit 21 acquires the current communication band of the network, and calculates the transmission time via the network between the edge terminal 20 and the cloud server 30 based on the data size of the compressed feature quantity.

By using the acquired, predicted, and calculated information, the determining unit 21 calculates an end-to-end delay that occurs if each division position candidate is selected. The determining unit 21 determines the division position candidate for which the end-to-end delay is smallest, as a division position. By using the acquired, predicted, and calculated information and a power consumption prediction model such as a regression model, the determining unit 21 may calculate power to be consumed by the edge terminal 20 if each division position candidate is selected, and determine the division position candidate for which the power to be consumed is smallest.

The determining unit 21 notifies the first inferring unit 22 and the encoding unit 23 of division position information indicating the determined division position, and notifies a decoding unit 31 and a second inferring unit 32 of the cloud server 30 described later of the division position information.

The first inferring unit 22 acquires the target model 41 from the training apparatus 10, and sets, as the edge model 43, a layer group from the input layer of the target model 41 to a division position indicated by the division position information which the first inferring unit 22 is notified of by the determining unit 21. The first inferring unit 22 performs inference processing on input data by using the edge model 43. The first inferring unit 22 acquires a feature quantity that is an output from the edge model 43, for example, a feature quantity at the division position, and transfers the feature quantity to the encoding unit 23.

The encoding unit 23 acquires, from the training apparatus 10, the encoder 44 of the trained AE 42 corresponding to the division position indicated by the division position information which the encoding unit 23 is notified of by the determining unit 21, and stores the encoder 44 in the predetermined storage area. The encoding unit 23 inputs the feature quantity transferred from the first inferring unit 22 to the encoder 44, and transmits the feature quantity compressed by the encoder 44 to the cloud server 30.

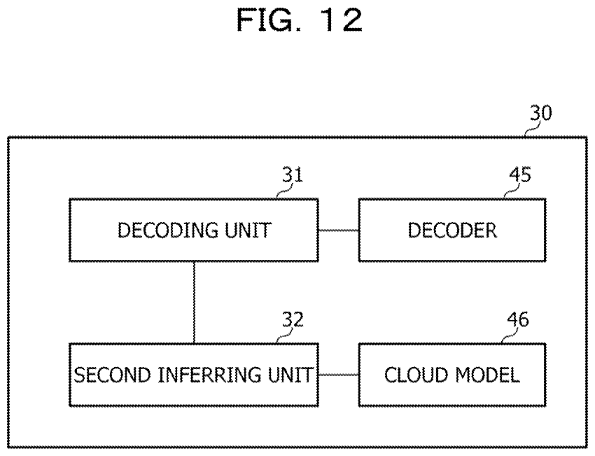

FIG. 12 is a functional block diagram of the cloud server 30. As illustrated in FIG. 12, the cloud server 30 includes the decoding unit 31 and the second inferring unit 32 in terms of functions. A decoder 45 and a cloud model 46 are stored in a predetermined storage area of the cloud server 30.

The decoding unit 31 acquires, from the training apparatus 10, the decoder 45 of the trained AE 42 corresponding to the division position indicated by the division position information which the decoding unit 31 is notified of by the determining unit 21, and stores the decoder 45 in the predetermined storage area. The decoding unit 31 acquires the compressed feature quantity transmitted from the edge terminal 20, inputs the compressed feature quantity to the decoder 45, decompresses the compressed feature quantity, and transfers the decompressed feature quantity to the second inferring unit 32.

The second inferring unit 32 acquires the target model 41 from the training apparatus 10, and sets, as the cloud model 46, a layer group from the division position indicated by the division position information which the second inferring unit 32 is notified of by the determining unit 21 to the output layer of the target model 41. The second inferring unit 32 performs, by using the cloud model 46, inference processing on the decompressed feature quantity transferred from the decoding unit 31, and outputs an inferred result.

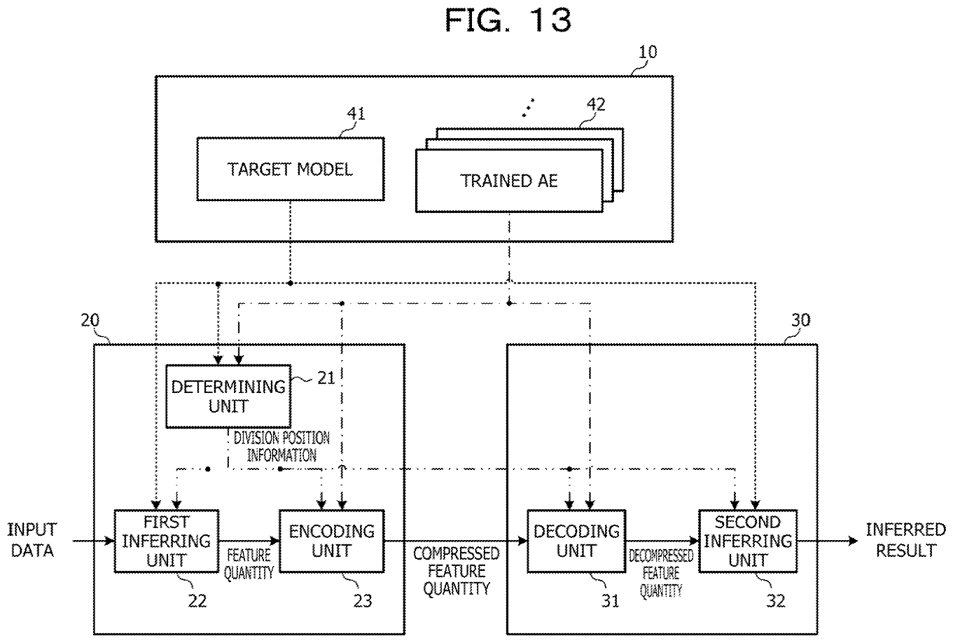

FIG. 13 illustrates relationships among the target model 41 and the trained AEs 42 stored in the training apparatus 10 and the individual functional units of the edge terminal 20 and the cloud server 30. The determining unit 21, the first inferring unit 22, and the second inferring unit 32 acquire the target model 41 from the training apparatus 10. The determining unit 21, the encoding unit 23, and the decoding unit 31 acquire the trained AEs 42 from the training apparatus 10. The determining unit 21 determines the division position and notifies the first inferring unit 22, the encoding unit 23, the decoding unit 31, and the second inferring unit 32 of the division position information.

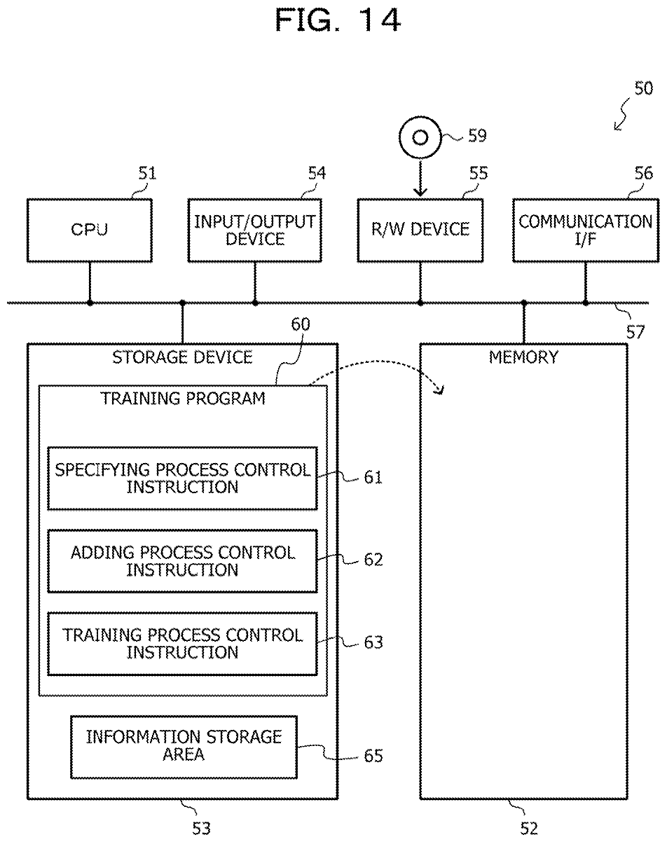

The training apparatus 10 may be implemented by a computer 50 illustrated in FIG. 14, for example. The computer 50 includes a central processing unit (CPU) 51, a memory 52 serving as a temporary storage area, and a nonvolatile storage device 53. The computer 50 also includes an input/output device 54 such as an input device and a display device, and a read/write (R/W) device 55 that controls reading and writing of data from and to a storage medium 59. The computer 50 also includes a communication interface (I/F) 56 that is coupled to a network such as Internet. The CPU 51, the memory 52, the storage device 53, the input/output device 54, the R/W device 55, and the communication I/F 56 are coupled to each other via a bus 57.

For example, the storage device 53 is a hard disk drive (HDD), a solid state drive (SSD), a flash memory, or the like. A training program 60 for causing the computer 50 to function as the training apparatus 10 is stored in the storage device 53 serving as a storage medium. The training program 60 includes a specifying process control instruction 61, an adding process control instruction 62, and a training process control instruction 63. The storage device 53 includes an information storage area 65 in which information constituting the target model 41 is stored.

The CPU 51 reads the training program 60 from the storage device 53, loads the training program 60 to the memory 52, and sequentially executes the control instructions included in the training program 60. By executing the specifying process control instruction 61, the CPU 51 operates as the specifying unit 11 illustrated in FIG. 6. By executing the adding process control instruction 62, the CPU 51 operates as the adding unit 12 illustrated in FIG. 6. By executing the training process control instruction 63, the CPU 51 operates as the training unit 13 illustrated in FIG. 6. The CPU 51 reads the information from the information storage area 65 and loads the target model 41 to the memory 52. Consequently, the computer 50 that executes the training program 60 functions as the training apparatus 10. The CPU 51 that executes the program is hardware.

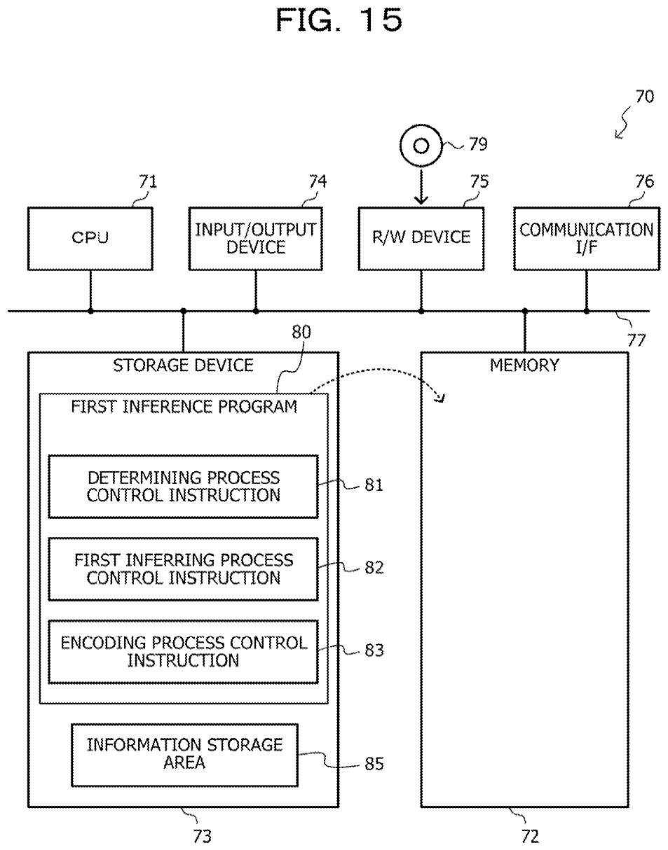

The edge terminal 20 may be implemented by a computer 70 illustrated in FIG. 15, for example. The computer 70 includes a CPU 71, a memory 72, a storage device 73, an input/output device 74, a R/W device 75 that controls reading and writing of data from and to a storage medium 79, and a communication I/F 76. The CPU 71, the memory 72, the storage device 73, the input/output device 74, the R/W device 75, and the communication I/F 76 are coupled to each other via a bus 77.

For example, the storage device 73 is an HDD, an SSD, a flash memory, or the like. A first inference program 80 for causing the computer 70 to function as the edge terminal 20 is stored in the storage device 73 serving as a storage medium. The first inference program 80 includes a determining process control instruction 81, a first inferring process control instruction 82, and an encoding process control instruction 83. The storage device 73 includes an information storage area 85 in which information constituting each of the edge model 43 and the encoder 44 is stored.

The CPU 71 reads the first inference program 80 from the storage device 73, loads the first inference program 80 to the memory 72, and sequentially executes the control instructions included in the first inference program 80. By executing the determining process control instruction 81, the CPU 71 operates as the determining unit 21 illustrated in FIG. 11. By executing the first inferring process control instruction 82, the CPU 71 operates as the first inferring unit 22 illustrated in FIG. 11. By executing the encoding process control instruction 83, the CPU 71 operates as the encoding unit 23 illustrated in FIG. 11. The CPU 71 reads the information from the information storage area 85, and loads each of the edge model 43 and the encoder 44 to the memory 72. Consequently, the computer 70 that executes the first inference program 80 functions as the edge terminal 20. The CPU 71 that executes the program is hardware.

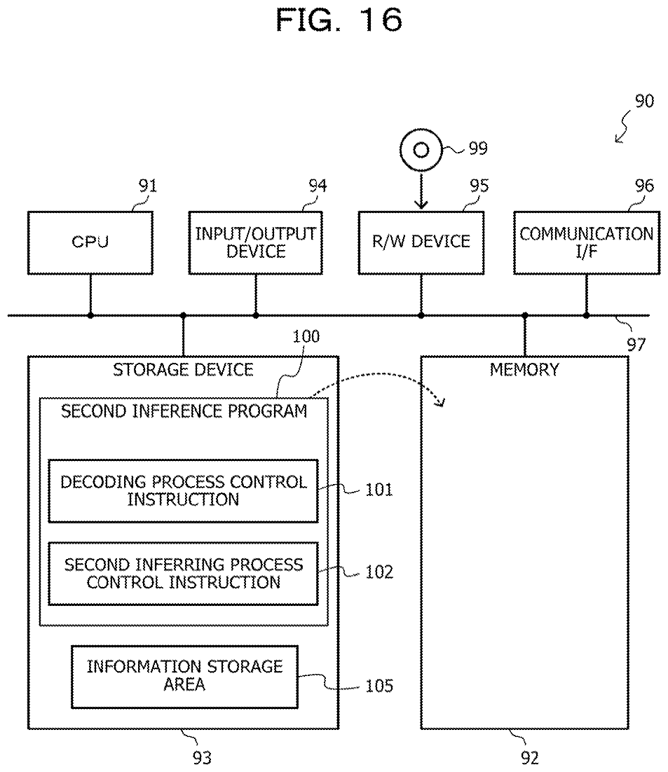

The cloud server 30 may be implemented by a computer 90 illustrated in FIG. 16, for example. The computer 90 includes a CPU 91, a memory 92, a storage device 93, an input/output device 94, a R/W device 95 that controls reading and writing of data from and to a storage medium 99, and a communication I/F 96. The CPU 91, the memory 92, the storage device 93, the input/output device 94, the R/W device 95, and the communication I/F 96 are coupled to each other via a bus 97.

For example, the storage device 93 is an HDD, an SSD, a flash memory, or the like. A second inference program 100 for causing the computer to function as the cloud server 30 is stored in the storage device 93 serving as a storage medium. The second inference program 100 includes a decoding process control instruction 101 and a second inferring process control instruction 102. The storage device 93 includes an information storage area 105 in which information constituting each of the decoder 45 and the cloud model 46 is stored.

The CPU 91 reads the second inference program 100 from the storage device 93, loads the second inference program 100 to the memory 92, and sequentially executes the control instructions included in the second inference program 100. By executing the decoding process control instruction 101, the CPU 91 operates as the decoding unit 31 illustrated in FIG. 12. By executing the second inferring process control instruction 102, the CPU 91 operates as the second inferring unit 32 illustrated in FIG. 12. The CPU 91 reads the information from the information storage area 105, and loads each of the decoder 45 and the cloud model 46 to the memory 92. Consequently, the computer 90 that executes the second inference program 100 functions as the cloud server 30. The CPU 91 that executes the program is hardware.

The functions implemented by each of the training program 60, the first inference program 80, and the second inference program 100 may be implemented by, for example, a semiconductor integrated circuit which is, for example, an application specific integrated circuit (ASIC), a field-programmable gate array (FPGA), or the like.

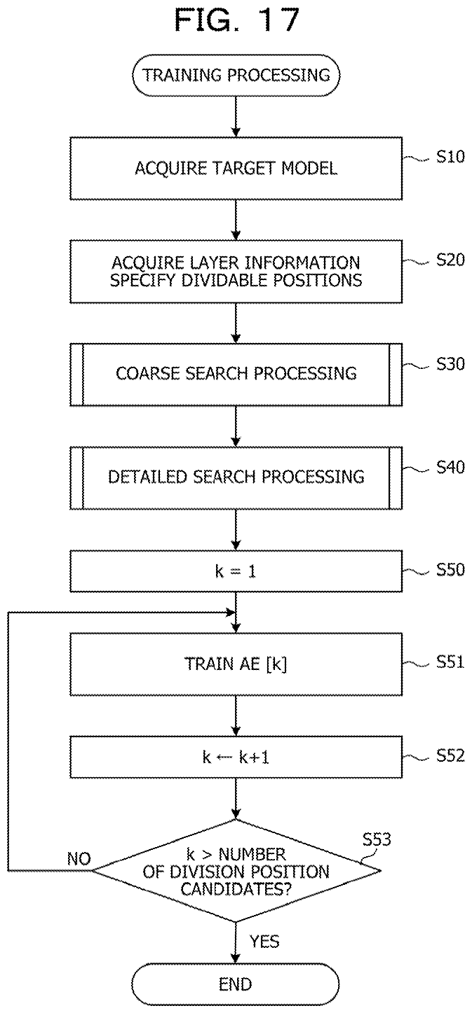

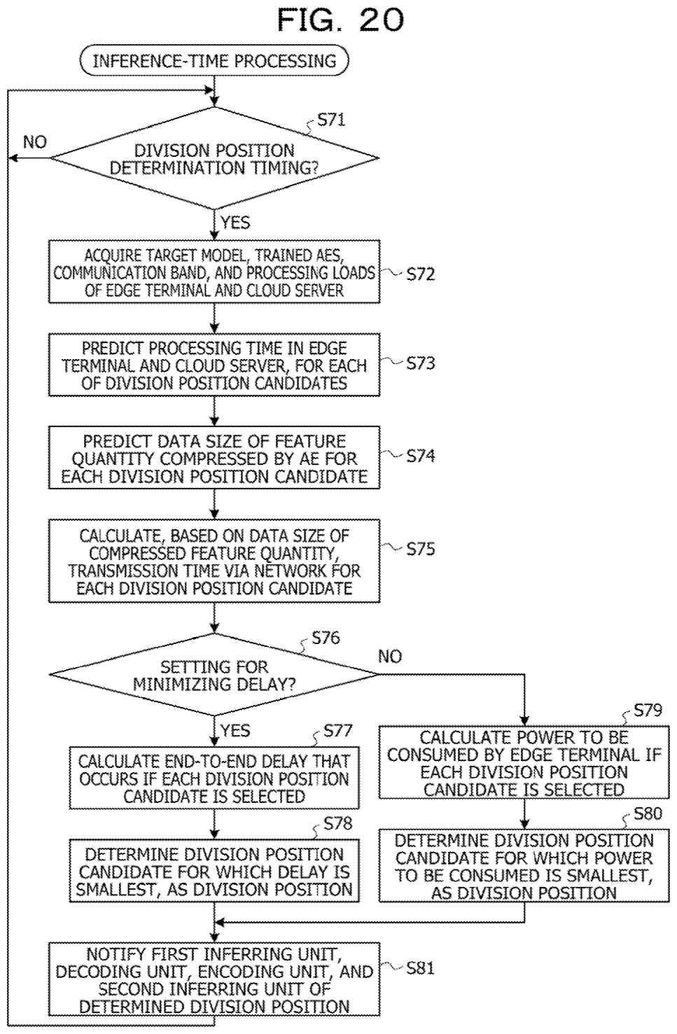

Operations of the AE training system 1 according to the present embodiment will be described. At the time of training of the AE, the training apparatus 10 performs training processing illustrated in FIG. 17. At the time of inference, the determining unit 21 of the edge terminal 20 performs inference-time processing illustrated in FIG. 20. The training processing and the inference-time processing are an example of an autoencoder training method according to the disclosed technology.

The training processing illustrated in FIG. 17 will be described.

In step S10, the specifying unit 11 acquires the target model 41. In step S20, the specifying unit 11 analyzes the target model 41 and acquires, as layer information, the number of pixels and the number of channels output by each layer. The specifying unit 11 specifies the position immediately behind each layer as the dividable position.

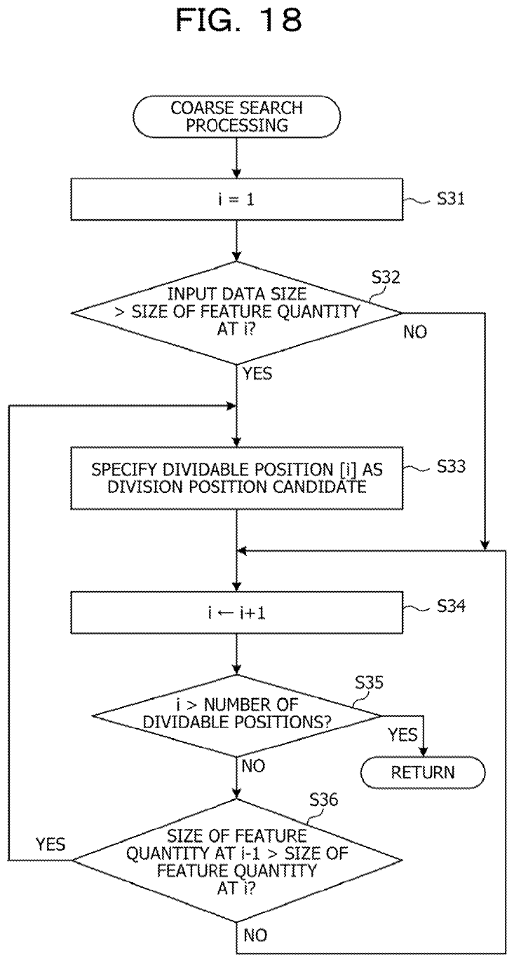

In step S30, coarse search processing is performed. The coarse search processing will be described with reference to FIG. 18.

In step S31, the specifying unit 11 sets a variable i for specifying the dividable position to 1. Hereinafter, an i-th (i=1, 2, . . . ) dividable position sequentially from the input layer side of the target model 41 is denoted by “dividable position [i]”.

In step S32, the specifying unit 11 acquires the data size of the feature quantity at the dividable position [i] from the layer information, and determines whether the data size of the feature quantity at the dividable position [i] is smaller than an input data size. If the data size of the feature quantity at the dividable position [i] is smaller than the input data size, the processing proceeds to step S33, in which the specifying unit 11 specifies the dividable position [i] as a division position candidate and then the processing proceeds to step S34. On the other hand, if the data size of the feature quantity at the dividable position [i] is greater than or equal to the input data size, the processing proceeds to step S34.

In step S34, the specifying unit 11 increments i by 1. In step S35, the specifying unit 11 determines whether i exceeds the number of dividable positions in the target model 41. If i does not exceed the number of dividable positions, the processing proceeds to step S36.

In step S36, the specifying unit 11 acquires the data size of the feature quantity at the dividable position [i−1] from the layer information. The specifying unit 11 determines whether the data size of the feature quantity at the dividable position [i] is smaller than the data size of the feature quantity at the dividable position [i−1]. If the data size of the feature quantity at the dividable position [i] is smaller than the data size of the feature quantity at the dividable position [i−1], the processing proceeds to step S33. On the other hand, if the data size of the feature quantity at the dividable position [i] is greater than or equal to the data size of the feature quantity at the dividable position [i−1], the processing proceeds to step S34.

If it is determined in step S35 that i exceeds the number of dividable positions, the coarse search processing ends and the processing returns to the training processing (FIG. 17).

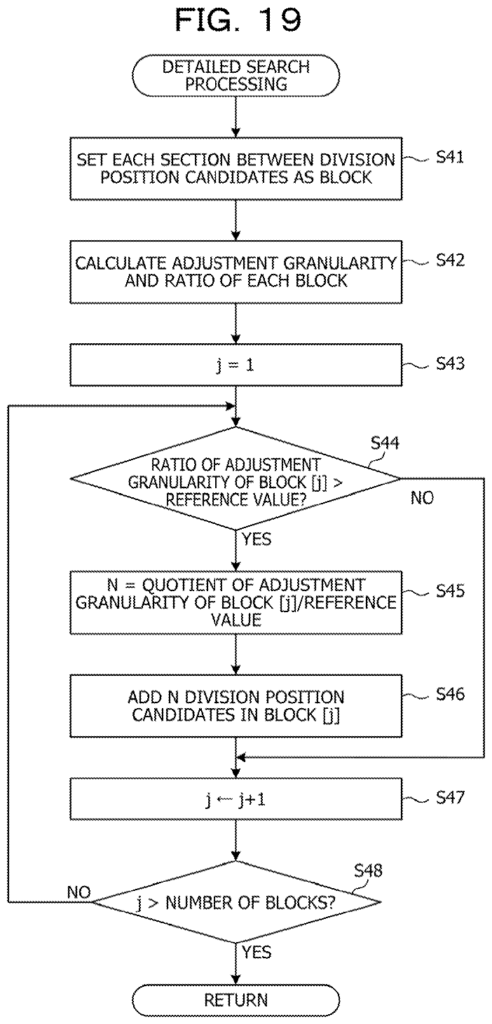

In step S40, detailed search processing is performed. The detailed search processing will be described with reference to FIG. 19.

In step S41, the adding unit 12 sets each section between the division position candidates as a block. Hereinafter, a j-th (i=1, 2, . . . ) block sequentially from the input layer side of the target model 41 is denoted by “block [j]”.

In step S42, the adding unit 12 calculates an amount of calculation for processing in a layer group included in each block, for example, an adjustment granularity. The adding unit 12 calculates a ratio of the adjustment granularity of each block to the adjustment granularity of all the blocks. In step S43, the adding unit 12 sets a variable j for specifying the block to 1.

In step S44, the adding unit 12 determines whether the ratio of the adjustment granularity of the block [j] is greater than a reference value. If the ratio of the adjustment granularity of the block [j] is greater than the reference value, the processing proceeds to step S45. If the ratio of the adjustment granularity of the block [j] is smaller than or equal to the reference value, the processing proceeds to step S47.

In step S45, the adding unit 12 calculates, as the number of to-be-added division position candidates N, a quotient of the ratio of the adjustment granularity of the block [j] divided by the reference value. In step S46, the adding unit 12 adds division position candidates at N dividable positions such that the adjustment granularities of respective blocks after the addition of the division position candidates become uniform as much as possible among the dividable positions in the block [j].

In step S47, the adding unit 12 increments j by 1. In step S48, the adding unit 12 determines whether j exceeds the number of blocks in the target model 41. If j does not exceed the number of blocks, the processing returns to step S44. If j exceeds the number of blocks, the detailed search processing ends and the processing returns to the training processing (FIG. 17).

In step S50, the training unit 13 sets a variable k for specifying the AE for each division position candidate to 1. Hereinafter, an AE to be inserted at a k-th (k=1, 2, . . . ) division position candidate sequentially from the input layer side of the target model 41 is denoted by “AE [k]”. In step S51, the training unit 13 trains AE [k] to optimize a loss function including an error between a compression-target original feature quantity and a decompressed feature quantity and a compression rate. The training unit 13 stores the trained AE [k] in the predetermined storage area.

In step S52, the training unit 13 increments k by 1. In step S53, the training unit 13 determines whether k exceeds the number of division position candidates in the target model 41. If k does not exceed the number of division position candidates, the processing returns to step S51. If k exceeds the number of division position candidates, the training processing ends.

The inference-time processing illustrated in FIG. 20 will be described.

In step S71, the determining unit 21 determines whether a division position determination timing is reached. The division position determination timing may be a timing after an elapse of a certain period, a timing at which a change in the band of the network is detected, or the like. If the division position determination timing is reached, the processing proceeds to step S72. If the division position determination timing is not reached, the determination in this step is repeated.

In step S72, the determining unit 21 acquires the target model 41 and the trained AE 42 for each division position candidate from the training apparatus 10. The determining unit 21 acquires the current communication band of the network and the current processing load of each of the edge terminal 20 and the cloud server 30. In step S73, based on the acquired information, the determining unit 21 predicts, for each division position candidate, a processing time in each of the edge terminal 20 and the cloud server 30 by using a processing time prediction model such as a regression model.

In step S74, the determining unit 21 predicts the data size of the feature quantity after the feature quantity which is the output of the edge model 43 at each division position candidate is compressed by the trained AE 42 corresponding to that division position candidate. In step S75, based on the current communication band of the network and the data size of the compressed feature quantity, the determining unit 21 calculates the transmission time via the network between the edge terminal 20 and the cloud server 30.

In step S76, the determining unit 21 determines whether the requisite of the application is a setting for minimizing the end-to-end delay or a setting for minimizing the power to be consumed by the edge terminal 20. In a case of the setting for minimizing the end-to-end delay, the processing proceeds to step S77. In a case of the setting for minimizing the power to be consumed by the edge terminal 20, the processing proceeds to step S79.

In step S77, by using the acquired, predicted, and calculated information, the determining unit 21 calculates the end-to-end delay that occurs if each division position candidate is selected. In step S78, the determining unit 21 determines the division position candidate for which the end-to-end delay is smallest, as the division position.

On the other hand, in step S79, by using the acquired, predicted, and calculated information and the power consumption prediction model such as a regression model, the determining unit 21 calculates power to be consumed by the edge terminal 20 if each division position candidate is selected. In step S80, the determining unit 21 determines the division position candidate for which the power to be consumed by the edge terminal 20 is smallest, as the division position.

In step S81, the determining unit 21 notifies the first inferring unit 22, the encoding unit 23, the decoding unit 31, and the second inferring unit 32 of the division position information indicating the determined division position. The inference-time processing then ends.

Consequently, the target model 41 is divided into the edge model 43 and the cloud model 46 at the determined division position, and the edge model 43 and the cloud model 46 are respectively deployed in the edge terminal and the cloud server 30. The encoder of the trained AE 42 for the determined division position is deployed on the output side of the edge model 43 of the edge terminal 20, and the decoder of the trained AE 42 is deployed on the input side of the cloud model 46 in the cloud server 30.

The first inferring unit 22 performs, by using the edge model 43, the inference processing on the input data, and acquires the feature quantity for the division position. The encoding unit 23 inputs the feature quantity to the encoder 44, and transmits the compressed feature quantity obtained by the encoder 44 to the cloud server 30.

The decoding unit 31 acquires the compressed feature quantity transmitted from the edge terminal 20, inputs the compressed feature quantity to the decoder 45, and decompresses the compressed feature quantity. The second inferring unit 32 performs, by using the cloud model 46, the inference processing on the decompressed feature quantity and outputs an inferred result.

As described above, in the AE training system 1 according to the present embodiment, the training apparatus 10 specifies, as division position candidates, positions behind respective layers in which an amount of output data is reduced relative to an amount of input data, among layers included in the target model 41 that is a DNN model. The training apparatus 10 trains, for each of the division position candidates, an AE to be inserted between the edge terminal 20 in which the edge model 43 constituted by a layer group from an input layer to a division position is deployed and the cloud server 30 in which the cloud model 46 constituted by a layer group from the division position to an output layer is deployed. Thus, an amount of calculation related to training of the AE to be inserted at the division position of the DNN model may be reduced, compared to the case where training is performed for all the dividable positions of the DNN model.

In a case where an amount of calculation in a block between the division position candidates is greater than a reference value, the training apparatus 10 according to the present embodiment adds a division position candidate between the division position candidates. At this time, the training apparatus 10 adds one or more division position candidates, the number of which is a number with which amounts of calculation in respective blocks after the addition of the division position candidates become smaller than or equal to the reference value, at positions at which the amounts of calculation in the respective blocks become uniform as much as possible. Thus, the amount of calculation related to training of the AE may be reduced without impairing the adjustability according to the requisite of the application.

While the case where both the coarse search and the detailed search are performed has been described in the embodiment above, the coarse search alone may be performed.

While the case where the determining unit 21 is included as a functional unit of the edge terminal 20 has been described in the embodiment above, the determining unit 21 may be included in the training apparatus 10 or the cloud server 30.

Each of the training program 60, the first inference program 80, and the second inference program 100 is respectively stored (installed) in the storage devices 53, 73, and 93 in advance in the embodiment above. However, the disclosed technology is not limited this configuration. The training program 60, the first inference program 80, and the second inference program 100 according to the disclosed technology may be provided in a form of being stored in a storage medium such as a compact disc read-only memory (CD-ROM), a digital versatile disc ROM (DVD-ROM), a Universal Serial Bus (USB) memory, or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An autoencoder training system comprising:
a memory; and
a processor coupled to the memory and configured to:
specify, as division position candidates, positions behind respective layers in which an amount of output data is reduced relative to an amount of input data, among layers included in a deep neural network model; and
perform, for each of the division position candidates, machine learning on an autoencoder to be inserted between a first apparatus in which a first layer group from an input layer to a division position is deployed and a second apparatus in which a second layer group from the division position to an output layer is deployed.

2. The autoencoder training system according to claim 1, wherein the processor is configured to, in a case where an amount of calculation in a layer group included between the division position candidates is greater than a reference value, add a division position candidate between the division position candidates.

3. The autoencoder training system according to claim 2, wherein
the division position candidate includes one or more division position candidates, and
the processor is configured to add the one or more division position candidates, a number of which is a number with which amounts of calculation in respective layer groups included between the division position candidates after the addition of the one or more division position candidates become smaller than or equal to the reference value.

4. The autoencoder training system according to claim 2, wherein
the processor is configured to add the division position candidate at a position at which amounts of calculation in respective layer groups included between the division position candidates after the addition of the division position candidate become uniform.

5. The autoencoder training system according to claim 1, wherein
the processor is configured to perform the machine learning on the autoencoder to optimize a loss function that includes an error between an input and an output of the autoencoder and a compression rate.

6. The autoencoder training system according to claim 1, wherein the processor is configured to:
determine a division position at which the autoencoder is to be inserted from among the division position candidates, based on a communication band between the first apparatus and the second apparatus and a processing load of each of the first apparatus and the second apparatus; and
insert, at the division position, the autoencoder on which the machine learning has been performed for the division position and perform inference processing on processing-target data.

7. The autoencoder training system according to claim 6, wherein
a first processor in the first apparatus is configured to
extract, with the first layer group, a feature quantity from the processing-target data,
compress, with an encoder of the autoencoder, the extracted feature quantity, and
transmit the compressed feature quantity to the second apparatus, and
a second processor in the second apparatus is configured to
decompress, with a decoder of the autoencoder, the compressed feature quantity, and
perform, with the second layer group, the inference processing based on the decompressed feature quantity.

8. An autoencoder training method comprising:
specifying, as division position candidates, positions behind respective layers in which an amount of output data is reduced relative to an amount of input data, among layers included in a deep neural network model; and
performing, for each of the division position candidates, machine learning on an autoencoder to be inserted between a first apparatus in which a first layer group from an input layer to a division position is deployed and a second apparatus in which a second layer group from the division position to an output layer is deployed.

9. The autoencoder training method according to claim 8, further comprising:
in a case where an amount of calculation in a layer group included between the division position candidates is greater than a reference value, adding a division position candidate between the division position candidates.

10. The autoencoder training method according to claim 9, wherein
the division position candidate includes one or more division position candidates, and
the autoencoder training method further includes adding the one or more division position candidates, a number of which is a number with which amounts of calculation in respective layer groups included between the division position candidates after the addition of the one or more division position candidates become smaller than or equal to the reference value.

11. The autoencoder training method according to claim 9, further comprising:
adding the division position candidate at a position at which amounts of calculation in respective layer groups included between the division position candidates after the addition of the division position candidate become uniform.

12. The autoencoder training method according to claim 8, further comprising:
performing the machine learning on the autoencoder to optimize a loss function that includes an error between an input and an output of the autoencoder and a compression rate.

13. The autoencoder training method according to claim 8, further comprising:
determining a division position at which the autoencoder is to be inserted from among the division position candidates, based on a communication band between the first apparatus and the second apparatus and a processing load of each of the first apparatus and the second apparatus; and
inserting, at the division position, the autoencoder on which the machine learning has been performed for the division position and perform inference processing on processing-target data.

14. The autoencoder training method according to claim 13, further comprising:
extracting, by the first apparatus, with the first layer group, a feature quantity from the processing-target data,
compressing, by the first apparatus, with an encoder of the autoencoder, the extracted feature quantity,
transmitting, by the first apparatus, the compressed feature quantity to the second apparatus,
decompressing, by the second apparatus, with a decoder of the autoencoder, the compressed feature quantity, and
performing, by the second apparatus, with the second layer group, the inference processing based on the decompressed feature quantity.

15. A non-transitory computer-readable recording medium storing an autoencoder training program for causing a computer to execute a processing of:
specifying, as division position candidates, positions behind respective layers in which an amount of output data is reduced relative to an amount of input data, among layers included in a deep neural network model; and
performing, for each of the division position candidates, machine learning on an autoencoder to be inserted between a first apparatus in which a first layer group from an input layer to a division position is deployed and a second apparatus in which a second layer group from the division position to an output layer is deployed.

16. The non-transitory computer-readable recording medium according to claim 15, further comprising:
in a case where an amount of calculation in a layer group included between the division position candidates is greater than a reference value, adding a division position candidate between the division position candidates.

17. The non-transitory computer-readable recording medium according to claim 16, wherein
the division position candidate includes one or more division position candidates, and
the processing further includes adding the one or more division position candidates, a number of which is a number with which amounts of calculation in respective layer groups included between the division position candidates after the addition of the one or more division position candidates become smaller than or equal to the reference value.

18. The non-transitory computer-readable recording medium according to claim 16, further comprising:
adding the division position candidate at a position at which amounts of calculation in respective layer groups included between the division position candidates after the addition of the division position candidate become uniform.

19. The non-transitory computer-readable recording medium according to claim 15, further comprising:
performing the machine learning on the autoencoder to optimize a loss function that includes an error between an input and an output of the autoencoder and a compression rate.

20. The non-transitory computer-readable recording medium according to claim 15, further comprising:
determining a division position at which the autoencoder is to be inserted from among the division position candidates, based on a communication band between the first apparatus and the second apparatus and a processing load of each of the first apparatus and the second apparatus; and
inserting, at the division position, the autoencoder on which the machine learning has been performed for the division position and perform inference processing on processing-target data.
